(19) United States
(12) Patent Application Publication
(10) Pub. No.: US 2010/0220932 A1
(43) Pub. Date: Sep. 2, 2010

(54) SYSTEM AND METHOD FOR STEREO MATCHING OF IMAGES

(76) Inventors: Dong-Qing Zhang, Plainsboro, NJ (US); Izzat Izzat, Plainsboro, NJ (US); Ana Belen Benitez, Brooklyn, NY (US)

Correspondence Address: Robert D. Shedd, Patent Operations;THOMSON Licensing LLC, P.O. Box 5312, Princeton, NJ, 08543-5312, US

(21) Appl. No.: 12/664,471

(22) PCT Filed: Jun. 20, 2007
(86) PCT No.: PCT/US07/14376

§ 371 Date: Dec. 14, 2009

(51) Int. Cl. G06K 9/62

(52) U.S. Cl. 382/209

(57) ABSTRACT

A system and method for stereo matching of at least two images, e.g., a stereoscopic image pair, employing a global optimization function, e.g., a belief propagation function, that utilizes dynamic programming as a preprocessing step are provided. The system and method of the present disclosure provide for acquiring a first image and a second image from a scene, estimating the disparity of at least one point in the first image with at least one corresponding point in the second image, and minimizing the estimated disparity using a belief propagation function, e.g., a global optimization function, wherein the belief propagation function is initialized with a result of a deterministic matching function, e.g., dynamic programming, applied to the first and second image to speed up the belief propagation function. The system and method further generates a disparity map from the estimated disparity and converts the disparity map into a depth map.

### TECHNICAL FIELD OF THE INVENTION

The present disclosure generally relates to computer graphics processing and display systems, and more particularly, to a system and method for stereo matching of at least two images employing a global optimization function that utilizes dynamic programming as a preprocessing step.

### BACKGROUND OF THE INVENTION

Stereoscopic imaging is the process of visually combining at least two images of a scene, taken from slightly different viewpoints, to produce the illusion of three-dimensional depth. This technique relies on the fact that human eyes are spaced some distance apart and do not, therefore, view exactly the same scene. By providing each eye with an image from a different perspective, the viewer's eyes are tricked into perceiving depth. Typically, where two distinct perspectives are provided, the component images are referred to as the “left” and “right” images, also know as a reference image and complementary image, respectively. However, those skilled in the art will recognize that more than two viewpoints may be combined to form a stereoscopic image.

In 3D post-production, visual effects (VFX) workflow and three dimensional (3D) display applications, an important process is to infer a depth map from stereoscopic images consisting of left eye view and right eye view images. For instance, recently commercialized autostereoscopic 3D displays require an image-plus-depth-map input format, so that the display can generate different 3D views to support multiple viewing angles.

The process of infering the depth map from a stereo image pair is called stereo matching in the field of computer vision research since pixel or block matching is used to find the corresponding points in the left eye and right eye view images. Depth values are infered from the relative distance between two pixels in the images that correrspond to the same point in the scene.

Stereo matching of digital images is widely used in many computer vision applications (such as, for example, fast object modeling and prototyping for computer-aided drafting (CAD), object segmentation and detection for human-computer interaction (HCl), video compression, and visual surveillance) to provide 3D depth information. Stereo matching obtains images of a scene from two or more cameras positioned at different locations and orientations in the scene. These digital images are obtained from each camera at approximately the same time and points in each of the image are matched corresponding to a 3-D point in space. In general, points from different images are matched by searching a portion of the images and using constraints (such as an epipolar constraint) to correlate a point in one image to a point in another image.

There has been substantial prior work on stereo matching. Stereo matching algorithms can be classified into two categories: 1) matching with local optimization and 2) matching with global optimization. The local optimization algorithms only consider the pixel intensity difference while ignoring the spatial smoothness of the depth values. Consequently, depth values are often inaccurate in flat regions and discontinuity artifacts, such as holes, are often visible. Global optimization algorithms find optimal depth maps based on both pixel intensity difference and spatial smoothness of the depth map; thus, global optimization algorithms substantially improve the accuracy and visual look of the resulting depth map.

The main limitation of global optimization is low computation speed. In the category of global optimization methods, dynamic programming is a relatively faster approach than other more sophisticated algorithms such as belief propagation and graph-cuts because only horizontal smoothness is enforced. However, dynamic programming often results in vertical discontinuities in the resulting depth maps, yielding scanline artifacts (see FIG. 5B where scanline artifacts are encircled). Belief propagation is a more advanced optimization technique, which enforces smoothness along both the horizontal and vertical directions, but it consumes significantly more computational power than the dynamic programming method.

Therefore, a need exists for techniques for fast and efficient global optimization stereo matching methods that minimize discontinuity artifacts.

### SUMMARY

A system and method for stereo matching of at least two images, e.g., a stereoscopic image pair, employing a global optimization function, e.g., a belief propagation algorithm or function, that utilizes dynamic programming as a preprocessing step are provided. The system and method of the present disclosure provide for acquiring a first image and a second image from a scene, estimating the disparity of at least one point in the first image with at least one corresponding point in the second image, and minimizing the estimated disparity using a belief propagation function, e.g., a global optimization algorithm or function, wherein the belief propagation function is initialized with a result of a deterministic matching function applied to the first and second image to speed up the belief propagation function. The system and method further generates a disparity map from the estimated disparity for each of the at least one point in the first image with the at least one corresponding point in the second image and converts the disparity map into a depth map by inverting the disparity values of the disparity map. The depth map can then be utilized with the stereoscopic image pair for 3D playback.

According to an aspect of the present disclosure, a method of stereo matching at least two images is provided including acquiring a first image and a second image from a scene, estimating the disparity of at least one point in the first image with at least one corresponding point in the second image, and minimizing the estimated disparity using a belief propagation function, wherein the belief propagation function is initialized with a result of a deterministic matching function applied to the first and second image. The first and second images include a left eye view and a right eye view of a stereoscopic pair.

In one aspect, the deterministic matching function is a dynamic programming function.

In another aspect, the minimizing step further includes converting the deterministic result into a message function to be used by the belief propagation function.

In a further aspect, the method further includes generating a disparity map from the estimated disparity for each of the at least one point in the first image with the at least one corresponding point in the second image.

In yet another aspect, the method further includes converting the disparity map into a depth map by inverting the estimated disparity for each of the at least one point of the disparity map.

In a further aspect, the estimating the disparity step includes computing a pixel matching cost function and a smoothness cost function.

In another aspect, the method further includes adjusting at least one of the first and second images to align epipolars line of each of the first and second images to the horizontal scanlines of the first and second images.

According to another aspect of the present disclosure, a system for stereo matching at least two images is provided. The system includes means for acquiring a first image and a second image from a scene, a disparity estimator configured for estimating the disparity of at least one point in the first image with at least one corresponding point in the second image and for minimizing the estimated disparity using a belief propagation function, wherein the belief propagation function is initialized with a result of a deterministic matching function applied to the first and second image.

According to a further aspect of the present disclosure, a program storage device readable by a machine, tangibly embodying a program of instructions executable by the machine to perform method steps for stereo matching at least two images is provided, the method including acquiring a first image and a second image from a scene, estimating the disparity of at least one point in the first image with at least one corresponding point in the second image, and minimizing the estimated disparity using a belief propagation function, wherein the belief propagation function is initialized with a result of a deterministic matching function applied to the first and second image.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is an exemplary illustration of a system for stereo matching at least two images according to an aspect of the present disclosure;

FIG. 2 is a flow diagram of an exemplary method for stereo matching at least two images according to an aspect of the present disclosure;

FIG. 3 illustrates the epipolar geometry between two images taken of a point of interest in a scene;

FIG. 4 is a flow diagram of an exemplary method for estimating disparity of at least two images according to an aspect of the present disclosure; and

FIG. 5 illustrates resultant images processed according to a method of the present disclosure, where FIG. 5A illustrates a left eye view input image and a right eye view input image, FIG. 5B is a resultant depth map processed by conventional dynamic programming, FIG. 5C is a resultant depth processed by the belief propagation method of the present disclosure and FIG. 5D shows a comparison of the conventional belief propagation approach with trivial initialization compared to the method of the present disclosure including belief propagation initialized by dynamic programming.

It should be understood that the drawing(s) is for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

Stereo matching is a standard methodology for inferring a depth map from stereoscopic images, e.g., a left eye view image and right eye view image. 3D playback on conventional autostereoscopic displays has shown that the smoothness of the depth map significantly affects the look of the resulting 3D playback. Non-smooth depth maps often result in zig-zaging edges in 3D playback, which are visually worse than the playback of a smooth depth map with less accurate depth values. Therefore, the smoothness of depth map is more important than the depth accuracy for 3D display and playback applications. Furthermore, global optimization based approaches are necessary for depth estimation in 3D display applications. This disclosure presents a speedup scheme for stereo matching of images based on a belief propagation algorithm or function, e.g., a global optimization function, which enforces smoothness along both the horizontal and vertical directions, wherein the belief propagation algorithm or function uses dynamic programming among other low-cost algorithms or functions as a preprocessing step.

A system and method for stereo matching of at least two images, e.g., a stereoscopic image pair, employing a global optimization function, e.g., a belief propagation algorithm or function, that utilizes dynamic programming as a preprocessing step are provided. The system and method of the present disclosure provide for acquiring a first image and a second image from a scene, estimating the disparity of at least one point in the first image with at least one corresponding point in the second image, and minimizing the estimated disparity using a belief propagation function, e.g., a global optimization function, wherein the belief propagation function is initialized with a result of a deterministic matching function The system and method further generates a disparity map from the estimated disparity for each of the at least one point in the first image with the at least one corresponding point in the second image and converts the disparity map into a depth map by inverting the disparity values of the disparity map. The depth map or disparity map can then be utilized with stereoscopic image pair for 3D playback.

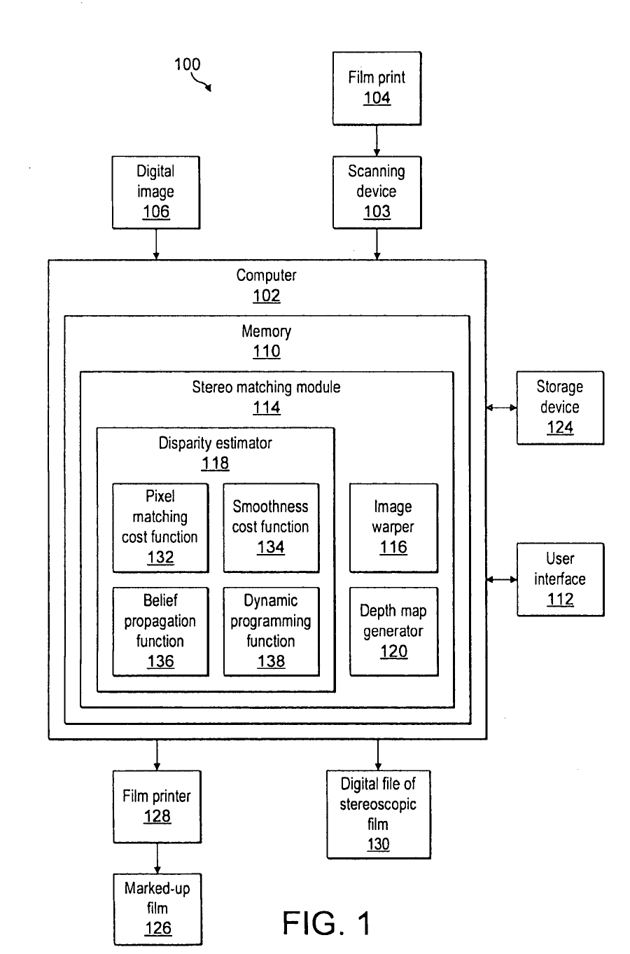

Referring now to the Figures, exemplary system components according to an embodiment of the present disclosure are shown in FIG. 1. A scanning device 103 may be provided for scanning film prints 104, e.g., camera-original film negatives, into a digital format, e.g. Cineon-format or Society of Motion Picture and Television Engineers (SMPTE) Digital Picture Exchange (DPX) files. The scanning device 103 may comprise, e.g., a telecine or any device that will generate a video output from film such as, e.g., an Arri LocPro™ with video output. Alternatively, files from the post production process or digital cinema 106 (e.g., files already in computer-readable form) can be used directly. Potential sources of computer-readable files are AVID™ editors, DPX files, D5 tapes, etc.

Scanned film prints are input to a post-processing device 102, e.g., a computer. The computer is implemented on any of the various known computer platforms having hardware such as one or more central processing units (CPU), memory 110 such as random access memory (RAM) and/or read only memory (ROM) and input/output (I/O) user interface(s) 112 such as a keyboard, cursor control device (e.g., a mouse or joystick) and display device. The computer platform also includes an operating system and micro instruction code. The various processes and functions described herein may either be part of the micro instruction code or part of a software application program (or a combination thereof) which is executed via the operating system. In one embodiment, the software application program is tangibly embodied on a program storage device, which may be uploaded to and executed by any suitable machine such as post-processing device 102. In addition, various other peripheral devices may be connected to the computer platform by various interfaces and bus structures, such a parallel port, serial port or [symbol] devices 124 and a printer 128. The printer 128 may be employed for printed a revised version of the film 126, e.g., a stereoscopic version of the film, wherein a scene or a plurality of scenes may have been altered or replaced using 3D modeled objects as a result of the techniques described below.

Alternatively, files/film prints already in computer-readable form 106 (e.g., digital cinema, which for example, may be stored on external hard drive 124) may be directly input into the computer 102. Note that the term “film” used herein may refer to either film prints or digital cinema.

A software program includes a stereo matching module 114 stored in the memory 110 for matching at least one point in a first image with at least one corresponding point in a second image. The stereo matching module 114 further includes an image warper 116 configured to adjust the epipolar lines of the stereoscopic image pair so that the epipolar lines are exactly the horizontal scanlines of the images.

The stereo matching module 114 further includes a disparity estimator 118 configured for estimating the disparity of the at least one point in the first image with the at least one corresponding point in the second image and for generating a disparity map from the estimated disparity for each of the at least one point in the first image with the at least one corresponding point in the second image. The disparity estimator 118 includes a pixel matching cost function 132 configured to match pixels in the first and second images and a smoothness cost function 134 to apply a smoothness constraint to the disparity estimation. The disparity estimator 118 further includes a belief propagation algorithm or function 136 for minimizing the estimated disparity and a dynamic programming algorithm or function 138 to initialize the belief propagation function 136 with a result of a deterministic matching function applied to the first and second image to speed up the belief propagation function 136.

The stereo matching module 114 further includes a depth map generator 120 for converting the disparity map into a depth map by inverting the disparity values of the disparity map.

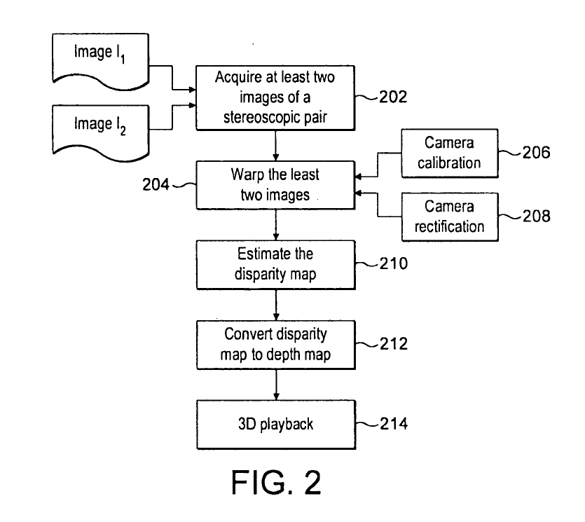

FIG. 2 is a flow diagram of an exemplary method for stereo matching of at least two two-dimensional (2D) images according to an aspect of the present disclosure. Initially, the post-processing device 102 acquires, at step 202, at least two 2D images, e.g., a stereo image pair with left and right eye views. The post-processing device 102 may acquire the at least two 2D images by obtaining the digital master image file in a computer-readable format. The digital video file may be acquired by capturing a temporal sequence of moving images with a digital camera. Alternatively, the video sequence may be captured by a conventional film-type camera. In this scenario, the film is scanned via scanning device 103.

It is to be appreciated that whether the film is scanned or already in digital format, the digital file of the film will include indications or information on locations of the frames, e.g., a frame number, time from start of the film, etc. Each frame of the digital image file will include one image, e.g., I₁, I₂, . . . Iₙ.

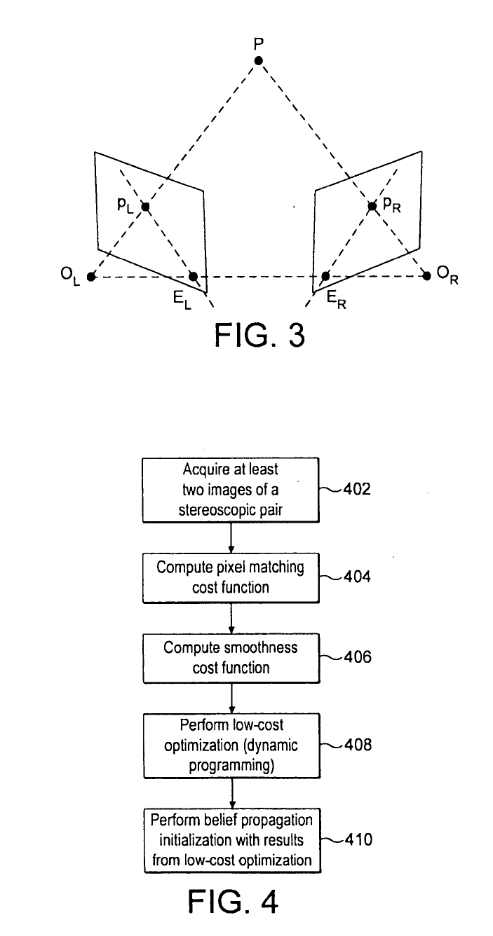

Stereoscopic images can be taken by two cameras with the same settings. Either the cameras are calibrated to have the same focal length, focal height and parallel focal plane; or the images have to be warped, at step 204, based on known camera parameters as if they were taken by the cameras with parallel focal planes. This warping process includes camera calibration, at step 206, and camera rectification, at step 208. The calibration and rectification process adjust the epipolar lines of the stereoscopic images so that the epipolar lines are exactly the horizontal scanlines of the images. Referring to FIG. 3, O_{L} and O_{R} represent the focal points of two cameras, P represents the point of interest in both cameras and p_{L} and p_{R} represent where point P is projected onto the image plane. The point of intersection on each focal plane is called the epipole (denoted by E_{L} and E_{R}). Right epipolar lines, e.g., E_{R}-p_{R}, are the projections on the right image of the rays connecting the [symbol] image to a pixel on the left image should be located at the epipolar line on the right image, likewise for the left epipolar lines, e.g., E_{L}-p_{L}. Since corresponding point finding happens along the epipolar lines, the rectification process simplifies the correspondence search to searching only along the scanlines, which greatly reduces the computational cost. Corresponding points are pixels in images that correspond to the same scene point.

Next, in step 210, the disparity map is estimated for every point in the scene. The disparity for every scene point is calculated as the relative distance of the matched points in the left and right eye images. For example, if the horizontal coordinate of a point in the left eye image is x, and the horizontal coordinate of its corresponding point in the right eye image is x′, then the disparity d=x′−x. Then, in step 212, the disparity value d for a scene point is converted into depth value z, the distance from the scene point to the camera, using the following formula: z=Bf/d, where B is the distance between the two cameras, also called baseline, and f is the focal length of the camera, the details of which will be described below.

With reference to FIG. 4, a method for estimating a disparity map, identified above as step 210, in accordance with the present disclosure is provided. Initially, a stereoscopic pair of images is acquired, at step 402. A disparity cost function is computed including computing a pixel cost function, at step 404, and computing a smoothness cost function, at step 406. A low-cost stereo matching optimization, e.g., dynamic programming, is performed to get initial deterministic results of stereo matching the two images, at step 408. The results of the low-cost optimization are then used to initialize a belief propagation function to speed up the belief propagation function for minimizing the disparity cost function, at step 410.

The disparity estimation and formulation thereof shown in FIG. 4 will now be described in more detail. Disparity estimation is an important step in the workflow described above. The problem consists of matching the pixels in left eye image and [symbol] the same scene point. By considering that the disparity map is smooth, the stereo matching problem can be formulated mathematically as follows:

C(d(.))=Cₚ(d(.))+λCₛ(d(.)) (1)

where d(.) is the disparity field, d(x, y) gives the disparity value of the point in the left eye image with coordinate (x, y), C is the overall cost function, Cₚ is the pixel matching cost function, and Cₛ is the smoothness cost function. The smoothness cost function is a function used to enforce the smoothness of the disparity map. During the optimization process, the above cost functional is minimized with respect to all disparity fields. For local optimization, the smoothness term Cₛ is discarded; therefore, smoothness is not taken into account during the optimization process. Cₚ can be modeled, among other forms, as the mean square difference of the pixel intensities:

$${C}_{p} ( d ( . ) ) = {\sum }_{x , y} {[ I ( x , y ) - {I}^{′} ( x - d ( x , y ) , y ) ]}^{2} \cdot \qquad ( 2 )$$

The smoothness constraint can be written differently depending on whether vertical smoothness is enforced or not. If both horizontal and vertical smoothness constraints are enforced, then, the smoothness cost function can be modeled as the following mean square error function:

$${C}_{s} ( d ( . ) ) = {\sum }_{x , y} {[ d ( x , y ) - d ( x + 1 , y ) ]}^{2} + {[ d ( x , y ) - d ( x , y + 1 ) ]}^{2} \qquad ( 3 )$$

In the case of dynamic programming, only horizontal smoothness is enforced, therefore, the smoothness cost function is modeled as follows:

$${C}_{s} ( d ( . ) ) = {\sum }_{x , y} {[ d ( x , y ) - d ( x + 1 , y ) ]}^{2} \qquad ( 4 )$$

Due to this simplification, dynamic programming only can be used to infer the depth map one scan line at a time because there is no need of optimizing the depth map across the entire image plane (especially, vertically).

The above cost function formulation can be converted into an equivalent

[symbol]

$$log p ( d ( . ) ) = {\sum }_{( i )} log {φ}_{i} ( {d}_{i} ) + {\sum }_{( ij )} log {ψ}_{ij} ( {d}_{i} , {d}_{j} ) - log Z \qquad ( 5 )$$

where i and j are single indices that identify one point in the image. For example, if an image has size 320×240, then i=0 represents the pixel at (0, 0), i=321 represents the pixel at (1, 1), and so on. Comparing Eq. (1) (2) (3), we have an overall cost function C=log p(d(.)), a pixel matching cost function

$${C}_{p} = {\sum }_{( i )} log {φ}_{i} ( {d}_{i} ) ,$$

a smoothness cost function

$${C}_{s} = {\sum }_{( ij )} log {ψ}_{ij} ( {d}_{i} , {d}_{j} ) ,$$

and

øᵢ(dᵢ)=exp((I(x, y)−I′(x−d(x, y))²),

ψᵢⱼ(dᵢ, dⱼ)=exp([d(x, y)−d(x±1, y)]²+[d(x, y)−d(x, y±1)]²)

where ± is used because the sign depends on the neighborhood of the pixels; pixel i and j are neighbor pixels; log Z is a constant with respect to the depth map, which does not affect the equivalence of Eq. (5) and Eq. (1). This way, minimizing Eq. (1) is equivalent to the maximizing Eq. (5). Eq. (5) is also called Markov Random Field formulation, where øᵢ and ψᵢⱼ are the potential functions of the Markov Random Field. Solving Eq. (5) can be either realized by maximizing it or by computing the approximated probability of the disparity. By computing the approximated probability, an approximated probability b(dᵢ=w) is computed that approximates the true probability p(dᵢ=w), the probability of the disparity of the point i (with coordinate x, y) taking the value of w. w is an integer number from 1 to M; where M is the maximum disparity value. The disparity value of the pixel i, then is the value of w that achieves the maximum b(dᵢ=w).

Belief propagation (BP) computes the approximated probability b(dᵢ=w) [i.e., b(dᵢ=w) is the probability that the disparity of pixel i equals to w] by using an iterative procedure called message passing. At each iteration, the messages are updated by the equation below

$${m}_{ij} ( {d}_{j} ) ← \sum {φ}_{i} ( {d}_{i} ) {ψ}_{ij} ( {d}_{i} , {d}_{j} ) {\prod }_{k ∈ N ( i ) \backslash j} {m}_{ki} ( {d}_{i} ) \qquad ( 6 )$$

where mᵢⱼ(dⱼ) is called the message that passes from i to j. The messages in general are initialized trivially to 1. Depending on different problems, message passing can take 1 to several hundred iterations to converge. After the above messages converge, the approximated probability is computed by the following equation:

$${b}_{i} ( {d}_{i} ) = k {φ}_{i} ( {d}_{i} ) {\prod }_{j ∈ N ( i )} {m}_{ji} ( {d}_{i} ) \qquad ( 7 )$$

where k is the normalization constant.

There are a number of ways to speed up the belief propagation algorithm or function. One way is to use a multi-scale scheme to refine the messages in a coarse-to-fine manner as is known in the art. The method of the present disclosure for speeding up the belief propagation algorithm is to reduce the number of iterations needed for conversion of the belief propagation algorithm. This is achieved by initializing the belief propagation messages using the stereo matching results from low-cost algorithms such as dynamic programming or other local optimization methods. Since low-cost algorithms only give deterministic results in the matching process rather than the message functions of the belief propagation algorithm, the stereo matching results are converted back to message functions. Using the relation as in Eq. (6)

$${b}_{i} ( {d}_{i} ) = k {φ}_{i} ( {d}_{i} ) {\prod }_{j ∈ N ( i )} {m}_{ji} ( {d}_{i} ) \qquad ( 8 )$$

and because the image is a 2D grid, a 4-neighborhood system is used, then the neighborhood pixel number of any pixel is 4. Assuming the messages associated to each node are the same, then a backward conversion is as follows:

$${m}_{ji} ( {d}_{i} ) = {( \frac{b ( {d}_{i} )}{{φ}_{i} ( {d}_{i} )} )}^{1 / 4} \qquad ( 9 )$$

The result of the low-cost algorithms is deterministic. Since the approximated probability b(xᵢ) needs to be computed, the deterministic matching results need to be converted into the approximated disparity probability bᵢ(xᵢ). The following approximation for the conversion is used:

bᵢ(dᵢ=w)=0.9 if dᵢ=w

bᵢ(dᵢ=w)=0.1 if dᵢ≠w (10)

where w is an integer ranging from 0 to the largest disparity value M (e.g., 20), and dᵢ is the disparity value of the pixel i output from the dynamic programming algorithm. Then, dᵢ is used to compute Eq. (10), then Eq. (9), then the resulting messages are used to initialize Eq. (6).

Referring back to FIG. 2, in step 212, the disparity value d for each scene point is converted into depth value z, the distance from the scene point to the camera, using the following formula: z=Bf/d, where B is the distance between the two cameras, also called baseline, and f is the focal length of the camera. The depth values for each at least one image, e.g., the left eye view image, are stored in a depth map. The corresponding image and associated depth map are stored, e.g., in storage device 124, and may be retrieved for 3D playback (step 214). Furthermore, all images of a motion picture or video clip can be stored with the associated depth maps in a single digital file 130 representing a stereoscopic version of the motion picture or clip. The digital file 130 may be stored in storage device 124 for later retrieval, e.g., to print a stereoscopic version of the original film.

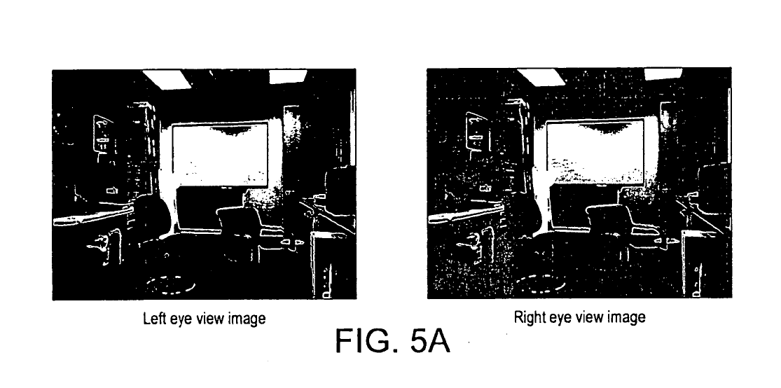

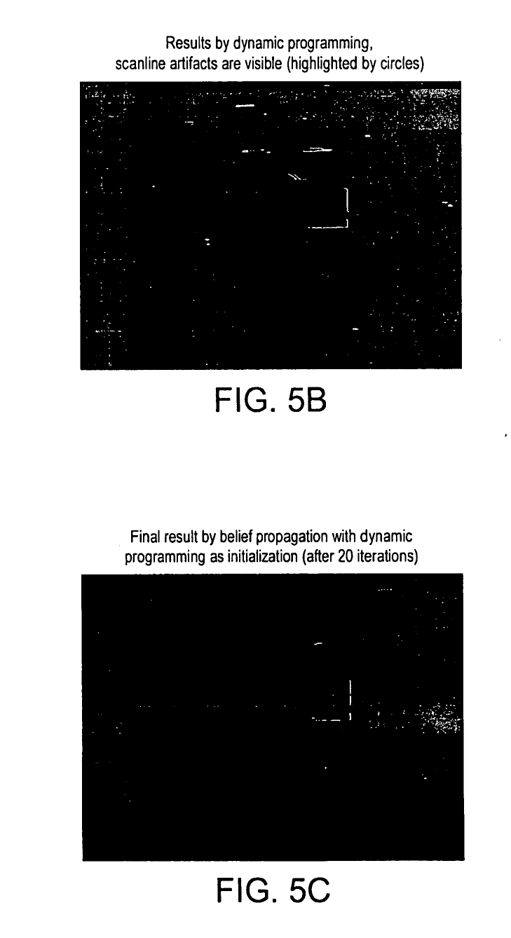

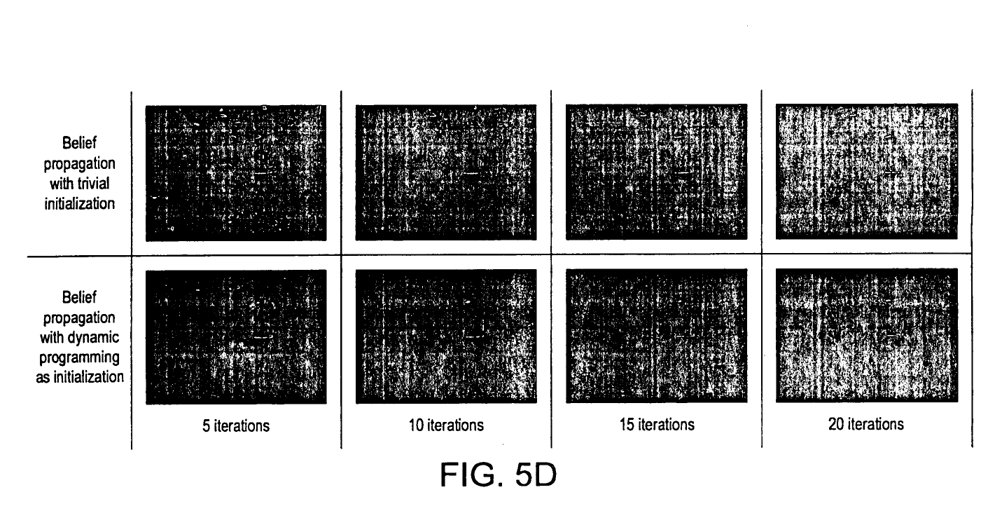

The initialization scheme of the present disclosure has been tested using several benchmarking images as shown in FIG. 5A including a left eye view image and a right eye view image. FIGS. 5B and 5C shows a comparison of conventional dynamic programming approach versus the method of the present disclosure including belief propagation initialized by dynamic programming. The dynamic programming approach, as shown in FIG. 5B, results in visible scanline artifacts. In order to achieve similar results to the image shown in FIG. 5C, the conventional dynamic programming approach needs about 80-100 iterations.

FIG. 5D shows the comparison of the conventional belief propagation approach with trivial initialization compared to the method of the present disclosure including belief propagation initialized by dynamic programming. FIG. 5D illustrates that by 20 iterations, the method of the present disclosure results in a disparity map significantly better than the conventional belief propagation approach.

Although embodiments which incorporates the teachings of the present disclosure have been shown and described in detail herein, those skilled in the art can readily devise many other varied embodiments that still incorporate these teachings. Having described preferred embodiments for a system and method for stereo matching of at least two images (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method of stereo matching at least two images, the method comprising:
acquiring a first image and a second image from a scene;
estimating the disparity of at least one point in the first image with at least one corresponding point in the second image; and
minimizing the estimated disparity using a belief propagation function, wherein the belief propagation function is initialized with a result of a deterministic matching function applied to the first and second image.

2. The method as in claim 1, wherein the deterministic matching function is a dynamic programming function.

3. The method as in claim 1, wherein the minimizing step further comprises converting the deterministic result into a message function to be used by the belief propagation function.

4. The method as in claim 1, further comprising generating a disparity map from the estimated disparity for each of the at least one point in the first image with the at least one corresponding point in the second image.

5. The method as in claim 4, further comprising converting the disparity map into a depth map by inverting the estimated disparity for each of the at least one point of the disparity map.

6. The method as in claim 1, wherein the first and second images include a left eye view and a right eye view of a stereoscopic pair.

7. The method as in claim 1, wherein the estimating the disparity step includes computing a pixel matching cost function.

8. The method as in claim 1, wherein the estimating the disparity step includes computing a smoothness cost function.

9. The method as in claim 1, further comprising adjusting at least one of the first and second images to align epipolars line of each of the first and second images to the horizontal scanlines of the first and second images.

10. A system for stereo matching at least two images comprising:
means for acquiring a first image and a second image from a scene;
a disparity estimator configured for estimating the disparity of at least one point in the first image with at least one corresponding point in the second image and for minimizing the estimated disparity using a belief propagation function, wherein the belief propagation function is initialized with a result of a deterministic matching function applied to the first and second image.

11. The system as in claim 10, wherein the deterministic matching function is a dynamic programming function.

12. The system as in claim 10, wherein the disparity estimator is further configured for converting the deterministic result into a message function to be used by the belief propagation function.

13. The system as in claim 10, wherein the disparity estimator is further configured for generating a disparity map from the estimated disparity for each of the at least one point in the first image with the at least one corresponding point in the second image.

14. The system as in claim 13, further comprising a depth map generator for converting the disparity map into a depth map by inverting the estimated disparity for each of the at least one point of the disparity map.

15. The system as in claim 10, wherein the first and second images include a left eye view and a right eye view of a stereoscopic pair.

16. The system as in claim 10, wherein the disparity estimator includes a pixel matching cost function.

17. The system as in claim 10, wherein the disparity estimator includes a smoothness cost function.

18. The system as in claim 10, further comprising an image warper configured for adjusting at least one of the first and second images to align epipolar lines of each of the first and second images to the horizontal scanlines of the first and second images.

19. A program storage device readable by a machine, tangibly embodying a program of instructions executable by the machine to perform method steps for stereo matching at least two images, the method comprising:
acquiring a first image and a second image from a scene;
estimating the disparity of at least one point in the first image with at least one corresponding point in the second image; and
minimizing the estimated disparity using a belief propagation function, wherein the belief propagation function is initialized with a result of a deterministic matching function applied to the first and second image.

20. The program storage device as in claim 19, wherein the deterministic matching function is a dynamic programming function.
